(19) United States
(12) Patent Application Publication
(10) Pub. No.: US 2003/0050763 A1
(43) Pub. Date: Mar. 13, 2003

(54) Referential and relational database software

(76) Inventors: Michael Arrit, Huntington, WV (US); John Hammack, Huntington, WV (US); Kenneth Meadows, Lesage, WV (US); Rita Riddle, Fredericksburg, VA (US)

Correspondence Address: Law Offices of John D. Gugliotta, PE, Esq., 202 Delaware Building, 137 South Main Street, Akron, OH, 44308, US

(21) Appl. No.: 10/231,715

(22) Filed: Aug. 30, 2002

Related U.S. Application Data
(60) Provisional application No. 60/315,810, filed on Aug. 30, 2001.

(51) Int. Cl. G06F 19/00; G01M 19/00

(52) U.S. Cl. 702/123

(57) ABSTRACT

A referential and relational database software comprising (a) programmable access for inputation of laboratory operating procedures; (b) communication between said software and testing instrumentation, said software extracting information from said instrumentation; (c) automatic population of designated database fields from said information; (d) manual population of designated database fields; and (e) review of information.

### RELATED APPLICATIONS

The present invention is a continuation of U.S. Provisional Patent No. 60/315,810.

### BACKGROUND OF THE INVENTION

1. Field of the Invention

The present invention relates generally to software database systems, and more specifically to a software database system integrally operable to a plurality of analytical machines, thereby directly populating, analyzing and storing data formulated from the analytical machines.

2. Description of the Related Art

At present, industrial laboratories employee a variety of software packages to closely monitor the quality control and/or quality assurance of the components used in manufacture and the end product(s). For instance, an industrial laboratory may use a software package for recording the measured data, a separate database software for entry of the measured data, a third software package for calibration of the testing instrumentation, and a fourth software package for tracking customer activity. The grouping of multiple software packages together to create a fully integrated laboratory has become a necessary investment for most industrial companies.

Consequently, there exists a need for new product ideas and enhancements for existing products in the software industry, especially as directed to an integrated database software system capable of replacing multiple systems with a single software system specially tailored to the needs of particular industrial laboratories.

### SUMMARY OF THE INVENTION

Software used within an industrial setting is often directed at a single application, such as a database designed for manual data entry of quality control measurements and information. If a company wishes to monitor quality control of the manufactured product, in addition to overseeing the calibration of the instruments used for data measurements and collection, or preserving a maintenance record for the instruments, that company must invest substantial financial capital in purchasing numerous software programs necessary to meet the aforementioned desires. In addition, that company will invest many hours in the installation, training and transition from older software to new to successfully implement the many software programs. As such, the present invention provides an integrated software system which offers a database designed for manual and automated data entry collected from quality control instrumentation, oversight of instrument calibration, preservation of maintenance records for the instrumentation, preserving operator qualification records, the tracking of customer activity and a variety of valuable industrial tracking applications. Thus, the present invention successfully overcomes the problems in existing software systems, and especially in relation to industrial laboratory applications.

Briefly described in accordance with the preferred embodiment of the present invention, the referential and relational database software system is a database having the capability of:

a. tracking and monitoring samples through the testing process;

b. monitoring the performance of each testing instrument against programmed standards;

c. monitoring quality control of the sample tested against programmed standards;

d. tracking customer activity;

e. providing real time transmission of data, thereby allowing immediate control and oversight by an operator or supervisor; and

f. providing the overall ability to a laboratory to monitor and recall every stage of activity in relation to manufactured products and the necessary components used to manufacture the product(s).

It is therefore an object of the present invention to provide a referential and relational database software program operating as an integrated system, thereby eliminating the costly and inefficient practice of using multiple software programs.

It is a feature of the present invention to provide a referential and relational database software program communicating with the laboratory instrumentation to provide a real time working assay.

The use of the present invention provides users with all of the materials and tools necessary to ensure that a user may install, use and/or maintain the referential and relational database software program.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a block diagram of the referential and relational database software;

FIG. 2 is a block diagram of the features of the apparatus of FIG. 1;

FIG. 3 is a block diagram of the features of the apparatus of FIG. 1; and

FIG. 4 is a block diagram of the features of the apparatus of FIG. 1.

### DESCRIPTION OF THE PREFERRED EMBODIMENTS

The best mode for carrying out the invention is presented in terms of its preferred embodiment, herein depicted within the Figures.

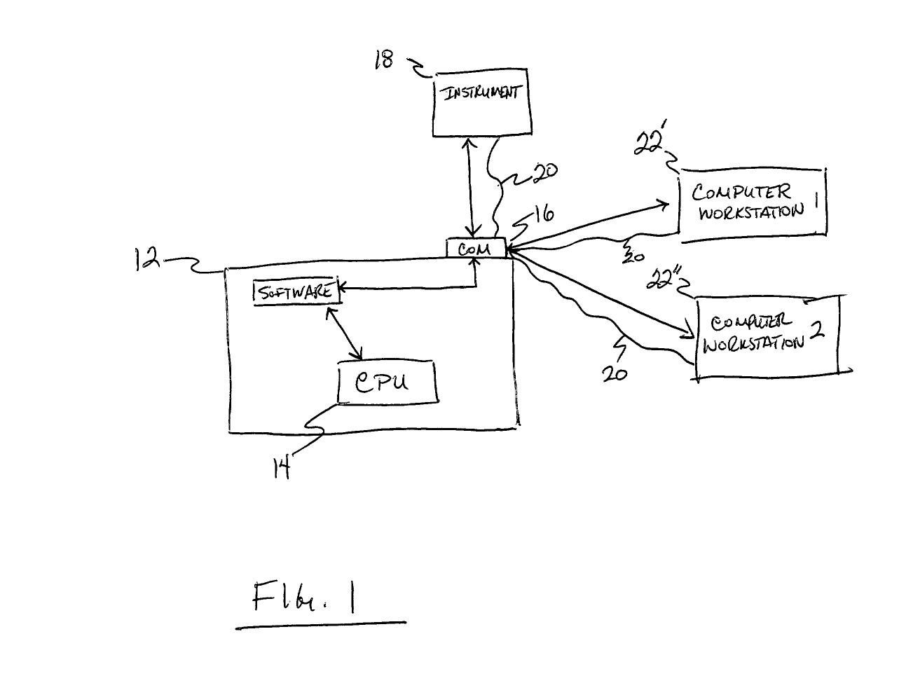

Referring now to FIG. 1, the referential and relational database software 10, in accordance with the present invention, is shown installed to the server 12 of a laboratory's computer hub. The software 10 interacts with a central processing unit (cpu) 14 and a communications port (com port) 16 for the transmission of information from device to device. The corn port 16 communicates with the instrumentation 18 via a serial cable 20. The corn port 16 further communicates with a plurality of computer workstations 22′ and 22″ through serial cables 20.

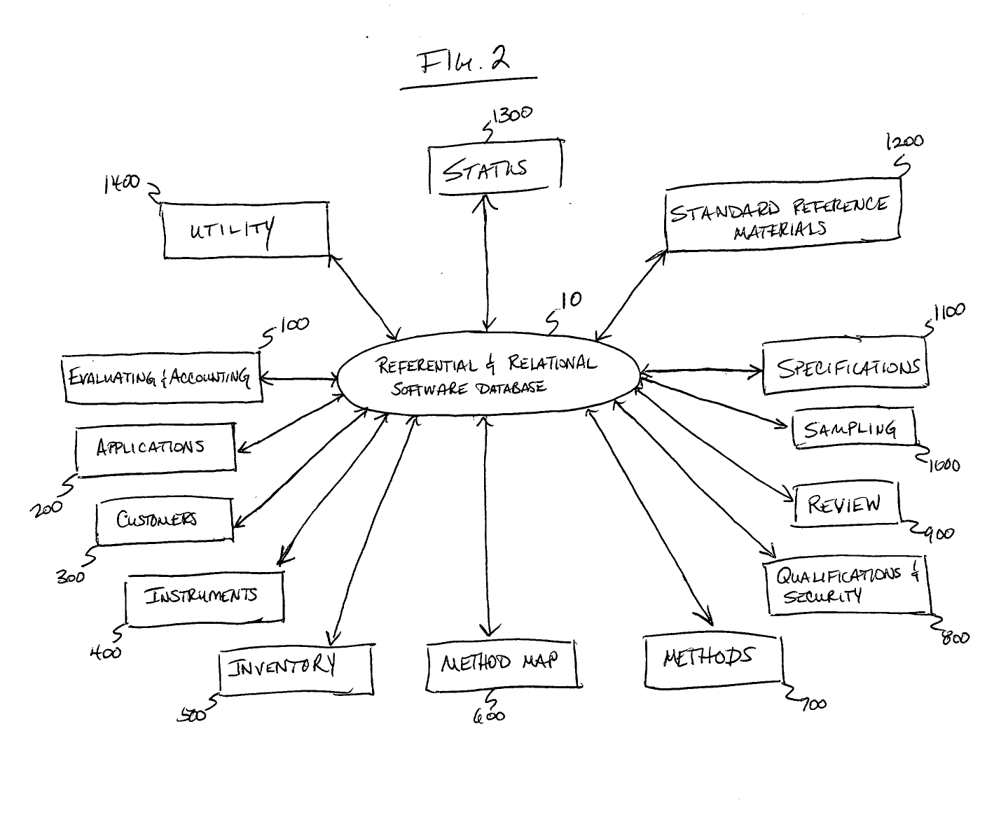

Referring now to FIG. 2, the referential and relational database software 10 is shown in a general overview to facilitate an understanding of the intricate components incorporated into the software 10. The software 10 includes segmented sections for evaluating and accounting 100, applications 200, customers 300, instruments 400, inventory 500, method mapping 600, methods 700, qualifications of laboratory technicians and security measures 800, review of sampling operations 900, sample selection and tracking 1000, specifications 1100, standard reference materials 1200, status of the system 1300 and stand alone utility modules 1400.

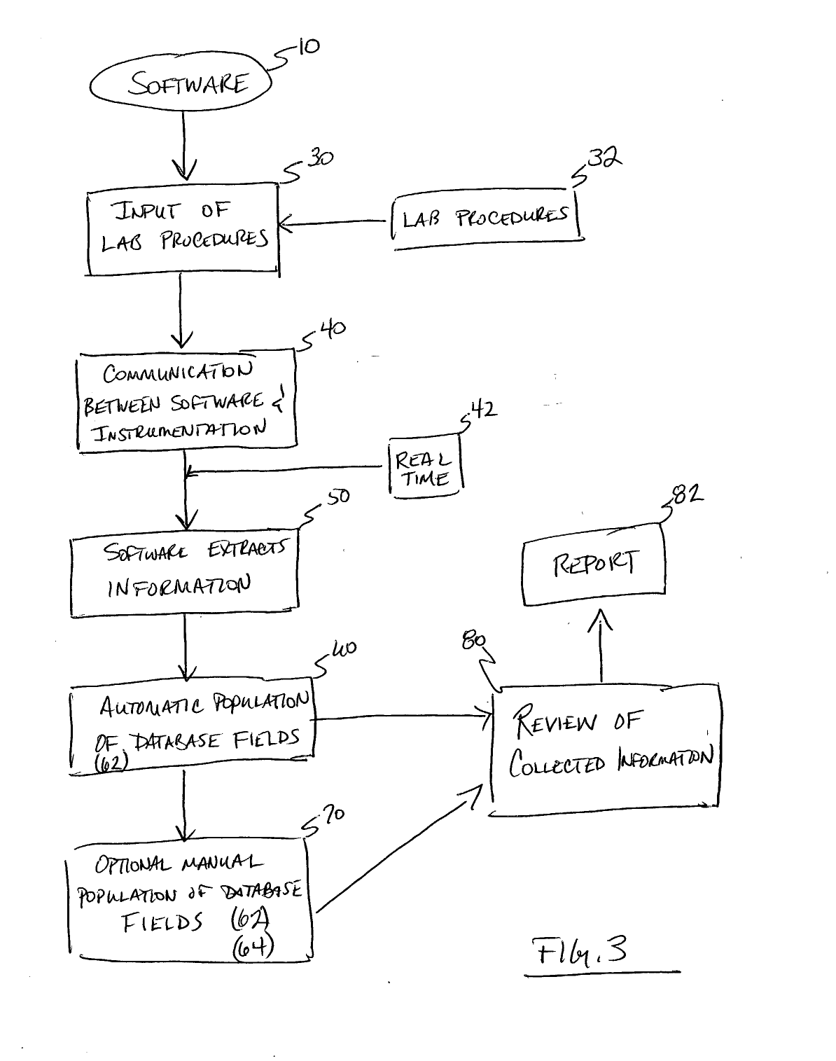

Referring now to FIG. 3, the referential and relational database software 10 includes programmable access for inputation 30 of laboratory operating procedures 32. The software 10 communicates with testing instrumentation 40, wherein the software 10 extracts information 50 from the instrumentation 18 in real time 42. As the software 10 extracts information 50 from the instrumentation 18, designated database fields 62 are automatically populated 60 with the extracted information 50. Manual population 70 of designated database fields 62 is provided as an option for pre-selected fields of for anomaly fields 64. Anomaly fields 64 are provided for manual population in which special calculations, such as conversion of units from standard to metric, or vice versa. After automated or manual population 60 or 70, the software 10 spools the information 50 into a reviewable 80 format, wherein a variety of review reports 82 may be generated for oversight and managerial control of laboratory processes 32.

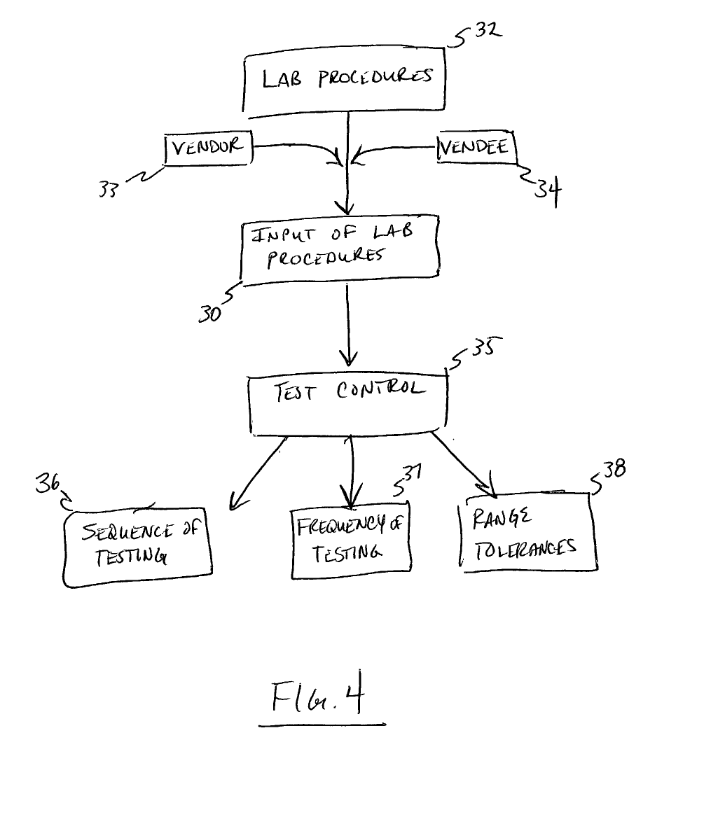

Referring now to FIG. 4, the programmable access necessary for inputation 30 of laboratory operating procedures 32 permits either a vendor 33 or a vendee 34 to input the standard laboratory operating procedures 32 of that particular laboratory. The software 10 is versatile and is adaptable for use in the simplest laboratories (having few laboratory or production procedures) or the most complex laboratories (having multiple levels of production). Preferably, the vendor 33 will customize the software 10 to suit the operating procedures 32 of the vendee 34. The operating procedures 32 will direct the software 10 to control methods of testing 35, sequence of testing 36, frequency of testing 37 and range tolerances 38.

The software 10 is integrated with the instrumentation 18 of the laboratory so as to provide communication 40 between the instrumentation 18 and a plurality of workstation computers 22′ and 22″. The communication 40 between the software 10 and the instrumentation 18 provides real time communication 40 such that as the instrumentation 18 measures and records the information, instantaneously the information is transmitted to workstation computers 22′ and 22″. The instantaneous transmission of information 50 to the workstation computers 22′ and 22″ is a working assay 52 because an operator can immediately analyze and detect any abnormalities in the testing process and efficiently correct any detected problems.

The information extracted from the instrumentation 18 includes data measured by the instrumentation 18 in analysis of a sample. The information may also include calibration data 83 of the instrumentation 18, wherein calibration data 83 is. integral in providing and maintaining the integrity of the testing process as designed. The information may also include operator data 84, such as the operator's name 85, department affiliation 86, biographical data 87 or qualifications 88. The operator's qualifications 88 may include the appropriate authorization 89 necessary to operate the instrumentation 18. The information may also include organizational data 90 of a laboratory's suppliers 91 or customers 92, thereby providing an efficient and effective means for tracking components that may be received by the lab, tested by the lab and shipped by the lab to other manufacturers. This feature of the software and especially important in industries, such as metal or plastics, in which many component parts are received and ultimately pieced together to form a product. It may be necessary to investigate the integrity of the component part, such as a piece of metal incorporated into an airplane that is later involved in an accident, for example.

After the software 10 has extracted the information from the instrumentation 18, the software 10 automatically populates 60 designated fields 62 within the database. The automated population 60 occurs in real time 42, in the same manner as the information is extracted. The automated population 60 of the form fields 62 provides an efficient means for the transmission and accessibility of information to a plurality of operators or supervisors. The automated population 60 also provides means for circumventing tedious data entry from operators and eliminates the potential for data entry error. If necessary, the software 10 is adaptable for the manual population 70 of designated fields 62 or anomaly fields 64, as described above.

The software 10, after extracting information 50 from the instrumentation 18 and populating 60 and 70 fields 62, provides for an integrated overview 80 of the information collected. The overview 80 may result, if desired, in a comprehensive report 82 customized by the operator or supervisor. The report 82 generated can provide detailed explanations and analysis of samples, the testing process, the performance of the instrumentation, customer activity, sample turnaround times, and standards used in calibration of the instrumentation 18.

It is envisioned that other styles and configurations of the present invention can be easily incorporated into the teachings of the present invention, and only one particular configuration shall be shown and described for purposes of clarity and disclosure and not by way of limitation of the scope.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A referential and relational database software comprising:
a. programmable access for inputation of laboratory operating procedures;
b. communication between said software and testing instrumentation, said software extracting information from said instrumentation;
c. automatic population of designated database fields from said information;
d. manual population of designated database fields; and
e. review of information.

2. The referential and relational database software of claim 1, wherein said laboratory operating procedures include a testing process and tolerance ranges for said testing process.

3. The referential and relational database software of claim 1, wherein said communication between said software and said instrumentation is in real time, said real time communication providing a working assay to an operator.

4. The referential and relational database software of claim 1, wherein said information is data measured by said testing instrumentation during said testing process.

5. The referential and relational database software of claim 1, wherein said information is calibration data taken from said testing instrumentation during said testing process, said calibration data analyzed to maintain integrity of said testing process.

6. The referential and relational database software of claim 1, wherein said information is operator data, said operator data includes name, department and qualifications of an operator.

7. The referential and relational database software of claim 5, wherein said operator qualifications include authorization to said operator of said testing instrumentation.

8. The referential and relational database software of claim 1, wherein said information is organizational data of suppliers and customers.

9. The referential and relational database software of claim 1, wherein said automatic population of designated database fields is in real time.

10. The referential and relational database software of claim 1, wherein said manual population of designated database fields includes anomaly fields, said anomaly fields having special calculations adaptable to said laboratory operating procedures.

11. The referential and relational database software of claim 1, wherein said review includes integrated management of testing samples, said testing process, said instrumentation, said information extracted from said instrumentation, said automated and manual population of database fields, said review combining said information and generating a report form.
